(19) United States
(12) Patent Application Publication
(10) Pub. No.: US 2020/0299043 A1
(43) Pub. Date: Sep. 24, 2020

(54) FULLY RECYCLABLE POLYETHYLENE PACKAGING

(71) Applicant: C.L.P. INDUSTRIES LTD., Kibbutz Negba (IL)

(72) Inventors: Gili DRORI, Ramat-HaSharon (IL); Lila SHPAKOVSKY, Yavne (IL)

(21) Appl. No.: 16/438,647

(22) Filed: Jun. 12, 2019

(30) Foreign Application Priority Data
Mar. 18, 2019 (IL) 265435

(51) Int. Cl. B65D 65/42; B32B 27/08; B32B 7/12; B32B 27/20; B32B 27/32; B29C 48/00; B29C 48/10; B29C 48/21

(52) U.S. Cl. CPC B65D 65/42; B29K 2023/065; B32B 7/12; B32B 27/20; B32B 27/327; B29C 48/0018; B29C 48/10; B29C 48/21; B32B 2255/10; B32B 2255/26; B32B 2255/20; B32B 2307/7244; B32B 2307/7246; B32B 2439/70; B32B 27/08

(57) ABSTRACT

A multilayer polymer film for use in packaging, particularly food packaging, and packaging made from the multilayer film, are disclosed, along with methods of manufacture of the multilayer film and the packaging. In preferred embodiments, the polymer film comprises an outer layer comprising machine direction oriented high-density polyethylene, an intermediate layer comprising adhesive and optionally ink, and an inner layer comprising high-density polyethylene, metallocene linear low-density polyethylene, and a plastomer. The inner or outer layer can be coated to lower the water vapor and oxygen transmission rates. In preferred embodiments, the layers are laminated to form the multilayer film. The multilayer film can be used to produce food packaging such as heat-sealable bags or pouches. Packaging made from the film is suitable for hot filling, and in contrast to packaging materials known in the art for hot filling, is fully recyclable.

### REFERENCE TO RELATED PUBLICATIONS

This application claims priority from Israel Pat. Appl. No. 265435, filed 18 Mar. 2019, and which is incorporated by reference in its entirety.

### FIELD OF THE INVENTION

This invention relates in general to multi-layer polymeric packaging and packaging materials. It relates in particular to fully recyclable packaging materials made from high-density polyethylene that have low permeability to moisture and oxygen.

### BACKGROUND OF THE INVENTION

Packaging materials comprising polymers of alkenes are widely used, due to the low cost, chemical inertness, and desirable physical properties such as light weight and attractive appearance of the materials. The lack of biodegradability of these polymers has made their use a significant environmental concern. In many cases, however, the packaging materials with optimal properties for uses such as food storage comprise polymers such as polystyrene that are not only not biodegradable, but also not recyclable. While polymers such as polyethylene and polypropylene are recyclable, their properties are such that they are frequently unsuitable for use as packaging materials (e.g. they typically cannot be heat-sealed at temperatures above 120° C.) in the absence of additives such as polyesters in quantities sufficiently high so as to preclude the possibility of the material being considered recyclable.

A great deal of effort has been expended to develop new packaging materials that can meet end-user requirements such as water vapor and oxygen permeability, mechanical strength, etc., while made of fully recyclable materials. Much of this effort has centered on the use of Machine-Direction Oriented (MDO) polymer films. In the MDO process, the polymer is heated and then passed between two rollers that rotate at different speeds, thereby forming the film; the ratio of the rollers' speeds is known as the “draw ratio.” The film can then be annealed or quenched. MDO films generally have improved stiffness, strength, puncture resistance, optical properties, and barrier properties relative to films made by other processes.

U.S. Pat. No. 6,311,491 discloses an MDO high-density polyethylene (HDPE) film suitable for use in packaging, and a bag made from the film disclosed therein. The films are made from HDPE having a weight average and number average molecular weight of between 1.3 million and 2.9 million, and are characterized by a thickness of less than 6 mil (˜150 μm) and a water vapor transmission rate of less than 0.28 g/100 in²/day/mil (0.17 g/m²/day/μm).

U.S. Pat. Appl. Pub. Nos. 2016/0229157 and 2016/0339663 disclose stand-up packaging for flowable foods that in preferred embodiments comprises more than 95% recyclable material. The packaging consists of multiple polymer layers, which generally comprise a number of sub-layers, that are laminated together to form the final product. In order to provide the stiffness necessary for stand-up packaging, each layer preferably contains at least one sub-layer comprising HDPE. In some embodiments, MDO polyethylene is used in order to improve the optical properties of the packaging material.

U.S. Pat. Appl. Pub. No. 2016/0001533 discloses a polyethylene packaging material suitable for use in stand-up packages. The material does not contain a significant amount of non-polyethylene polymer. The material comprises several layers of material that are laminated together and several of which comprise polyethylene having a multi-modal molecular weight distribution.

U.S. Pat. Appl. Pub. No. 2012/0033901 discloses a packaging container made from a laminated film comprising an outer layer made of MDO polyethylene, an inner layer made of a standard polyethylene film, and an intermediate bonding layer typically comprising an adhesive, to which additional degradable materials may be added. The properties of the polyethylene preferably used in the invention such as density, molecular weight distribution, melting point, and melt flow index, are not disclosed.

Despite the advances made in packaging technology as outlined above, improved packaging and packaging materials that retain the advantages of polyethylene, that are esthetically pleasing to the consumer, that are fully recyclable, that are suitable for as food packaging in general and for hot filling (85° C.) and heat sealing above 120° C. in particular, remain a long-felt, yet unmet need.

### SUMMARY OF THE INVENTION

The present invention is designed to meet this need. A multilayer film comprising an outer layer comprising high-density polyethylene (HDPE); an inner layer comprising HDPE, metallocene linear low-density polyethylene (mLLDPE), and a plastomer; and an intermediate layer preferably comprising an adhesive and a colorant such as an ink is disclosed, along with packaging made from the film, and methods of manufacture of the film and packaging. The packaging is suitable for use with food, hot filling, and heat sealing, and because the packaging material is primarily polyethylene, the multilayer film and packaging made therefrom are fully recyclable.

It is thus an object of the present invention to disclose packaging comprising a multilayer film, said multilayer film comprising:

an outer layer comprising high-density polyethylene (HDPE);

an inner layer comprising HDPE, metallocene linear low-density polyethylene (mLLDPE), and a plastomer; and,

an intermediate layer disposed between said outer layer and said inner layer, said intermediate layer comprising at least one component selected from the group consisting of adhesives, colorants, pigments, and dyes.

It is a further object of this invention to disclose such packaging as defined in any of the above, wherein said multilayer film is produced by lamination of said layers.

It is a further object of this invention to disclose such packaging as defined in any of the above, wherein said outer layer comprises machine-direction oriented HDPE (MDO-HDPE). In some preferred embodiments, said outer layer comprises MDO-HDPE made from HDPE characterized by at least one characteristic selected from the group consisting of: a peak melting point of 105-115° C.; and, a draw ratio of between 3 and 7.

It is a further object of this invention to disclose such packaging as defined in any of the above, wherein said outer layer is characterized by a thickness of between 20 μm and 40 μm. In some preferred embodiments of the invention, said outer layer is characterized by a thickness of about 25 μm.

It is a further object of this invention to disclose such packaging as defined in any of the above, wherein said inner layer comprises blown HDPE. In some preferred embodiments of the invention, said blown HDPE is produced at a blow-up ratio (BUR) of about 1:2.

It is a further object of this invention to disclose such packaging as defined in any of the above, wherein said inner layer is characterized by a thickness of between 40 μm and 100 μm. In some preferred embodiments of the invention, said inner layer is characterized by a thickness of about 60 μm.

It is a further object of this invention to disclose such packaging as defined in any of the above, wherein said inner layer comprises HDPE, mLLDPE, and plastomer layers characterized by thicknesses in a ratio of about 1:2:1.

It is a further object of this invention to disclose such packaging as defined in any of the above, wherein said inner layer comprises plastomer comprising at least one polymer selected from the group consisting of polyethylene and poly-α-olefin.

It is a further object of this invention to disclose such packaging as defined in any of the above, wherein said intermediate layer comprises adhesive and ink approved for use in food packaging.

It is a further object of this invention to disclose such packaging as defined in any of the above, wherein said packaging is characterized by at least one characteristic selected from the group consisting of: a water vapor transmission rate of 25-30 g/m²/day as determined by ASTM method F1249-06; and, an oxygen transmission rate of 25-30 cm³/m²/day as determined by ASTM method D3985.

It is a further object of this invention to disclose such packaging as defined in any of the above, wherein at least one of said outer layer and said inner layer is coated by a coating.

It is a further object of this invention to disclose such packaging as defined in any of the above, wherein said outer layer is coated with a coating comprising aluminum oxide. In some preferred embodiments of the invention, said coating comprising aluminum oxide is characterized by a thickness of 0.001 μm-0.005 μm. In some especially preferred embodiments of the invention, said coating comprising aluminum oxide is characterized by a thickness of about 0.002 μm.

It is a further object of this invention to disclose such packaging as defined in any of the above, wherein said inner layer is coated by a coating comprising poly-(ethylene vinyl alcohol) (EVOH). In some preferred embodiments of the invention, said coating comprising EVOH is characterized by a thickness of 3 μm-5 μm.

It is a further object of this invention to disclose such packaging as defined in any of the above, said packaging is characterized by at least one characteristic selected from the group consisting of: a water vapor transmission rate of 1.5-2.0 g/m²/day as determined by ASTM method F1249-06; and, an oxygen transmission rate of 2.5-4.5 cm³/m²/day as determined by ASTM method D3985.

It is a further object of this invention to disclose such packaging as defined in any of the above, wherein said packaging is in a form selected from the group consisting of bags and pouches. In some preferred embodiments of the invention, said packaging is in the form of a stand-alone pouch.

It is a further object of this invention to disclose such packaging as defined in any of the above, wherein said packaging is fully recyclable.

It is a further object of this invention to disclose a multilayer film suitable for use in food packaging, said multilayer film comprising:

an outer layer comprising high-density polyethylene (HDPE);

an inner layer comprising HDPE, mLLDPE, and a plastomer; and,

an intermediate layer disposed between said outer layer and said inner layer, said intermediate layer comprising at least one component selected from the group consisting of adhesives, colorants, pigments, and dyes.

It is a further object of this invention to disclose such a multilayer film, wherein said multilayer film is produced by lamination of said layers.

It is a further object of this invention to disclose a multilayer film as defined in any of the above, wherein said outer layer comprises machine-direction oriented HDPE (MDO-HDPE). In some preferred embodiments of the invention, said outer layer comprises MDO-HDPE made from HDPE characterized by a peak melting point of 105-115° C. In some preferred embodiments of the invention, said outer layer comprises MDO-HDPE produced at a draw ratio of between 3 and 7.

It is a further object of this invention to disclose a multilayer film as defined in any of the above, wherein said outer layer is characterized by a thickness of between 20 μm and 40 μm.

It is a further object of this invention to disclose a multilayer film as defined in any of the above, wherein said inner layer comprises blown HDPE.

It is a further object of this invention to disclose a multilayer film as defined in any of the above, wherein said inner layer is produced by co-extrusion of said HDPE, mLLDPE, and plastomer.

It is a further object of this invention to disclose a multilayer film as defined in any of the above, wherein said inner layer is characterized by a thickness of between 40 μm and 100 μm.

It is a further object of this invention to disclose a multilayer film as defined in any of the above, wherein said inner layer comprises HDPE, mLLDPE, and plastomer layers characterized by thicknesses in a ratio of about 1:2:1.

It is a further object of this invention to disclose a multilayer film as defined in any of the above, wherein said inner layer comprises plastomer comprising at least one polymer selected from the group consisting of polyethylene and poly-α-olefin.

It is a further object of this invention to disclose a multilayer film as defined in any of the above, wherein at least one of said outer layer and said inner layer is coated by a coating.

It is a further object of this invention to disclose a multilayer film as defined in any of the above, wherein said outer layer is coated by a coating comprising aluminum oxide. In some preferred embodiments of the invention, said coating comprising aluminum oxide is characterized by a thickness of 0.001 μm-0.005 μm. In some especially preferred embodiments of the invention, said coating comprising aluminum oxide is characterized by a thickness of about 0.002 μm.

It is a further object of this invention to disclose a multilayer film as defined in any of the above, wherein said inner layer is coated by a coating comprising EVOH. In some preferred embodiments of the invention, said coating comprising EVOH is characterized by a thickness of 3 μm-5 μm.

It is a further object of this invention to disclose a multilayer film as defined in any of the above, wherein said inner layer is coated by a coating that is co-extruded with said mLLDPE.

It is a further object of this invention to disclose a multilayer film as defined in any of the above, wherein said multilayer film is characterized by at least one characteristic selected from the group consisting of: a water vapor transmission rate of 1.5-2.0 g/m²/day as determined by ASTM method F1249-06; and, an oxygen transmission rate of 2.5-4.5 cm³/m²/day as determined by ASTM method D3985.

It is a further object of this invention to disclose a method of producing packaging suitable for use with food, said method comprising:

preparing an outer layer comprising an HDPE film characterized by a first thickness;

preparing an inner layer comprising a film HDPE, mLLDPE, and a plastomer, said inner layer characterized by a second thickness;

applying at least one substance selected from the group consisting of adhesives, colorants, pigments, and dyes to a surface of at least one of said outer layer and said inner layer, thereby forming an intermediate layer;

laminating said outer layer, inner layer and said intermediate layer such that said intermediate layer is disposed between said outer layer and said inner layer, thereby producing a multilayer film; and,

producing packaging characterized by an exterior and an interior and is open on at least one side, by a method selected from the group consisting of:

obtaining two pieces of said multilayer film and sealing together said two pieces of multilayer film such that said inner layers are facing each other in said interior and such that at least one side remains unsealed; and,

folding a piece of said multilayer film such that said inner layers face one another and sealing said folded piece of multilayer film such that at least one side remains unsealed.

It is a further object of this invention to disclose the method as defined in any of the above, wherein at least one of the following is true:

said first thickness is 20 μm-40 μm; and,

said second thickness is 40 μm-100 μm.

It is a further object of this invention to disclose the method as defined in any of the above, wherein at least one of the following is true:

said step of preparing an outer layer comprises preparing an outer layer comprising MDO-HDPE; and,

said step of preparing an inner layer comprises preparing an inner layer comprising blown HDPE, mLLDPE, and at least one plastomer selected from the group consisting of polyethylene and poly-α-olefin.

It is a further object of this invention to disclose the method as defined in any of the above, wherein said step of preparing an outer layer comprises preparing an outer layer comprising MDO-HDPE prepared at a draw ratio of 3-7.

It is a further object of this invention to disclose the method as defined in any of the above, wherein said step of preparing an inner layer comprises co-extruding said blown HDPE, mLLDPE, and at least one plastomer.

It is a further object of this invention to disclose the method as defined in any of the above, wherein said step of preparing an inner layer comprises preparing an inner layer in which said HDPE, said mLLDPE, and said plastomer are characterized by thicknesses having a ratio of about 1:2:1.

It is a further object of this invention to disclose the method as defined in any of the above, comprising at least one step selected from the group consisting of:

coating said outer layer with at least one outer layer coating material prior to said step of producing packaging; and,

coating said inner layer with at least one inner layer coating material prior to said step of producing packaging.

In some preferred embodiments of the invention, at least one of the following is true:

said outer layer coating material comprises aluminum oxide;

said step of coating said outer layer comprises coating said outer layer so as to produce a coating characterized by a thickness of 0.001 μm-0.005 μm;

said inner layer coating material comprises EVOH; and,

said step of coating said inner layer comprises coating said inner layer so as to produce a coating characterized by a thickness of 3 μm-5 μm.

In some preferred embodiments of the invention, at least one of the following is true:

said step of coating said outer layer comprises coating said outer layer with said outer layer coating material by vacuum deposition; and,

said step of coating said inner layer comprises co-extruding said inner layer coating material and said mLLDPE.

### DETAILED DESCRIPTION OF THE PREFERRED EMBODIMENTS

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore the invention is not limited by that which is illustrated in the FIGURE and described in the specification, but only as indicated in the accompanying claims, with the proper scope determined only by the broadest interpretation of said claims. In some cases, for clarity or conciseness, individual elements of the invention are discussed separately. Nonetheless, any combination of individual elements of the invention that is not self-contradictory is considered by the inventors to be within the scope of the invention.

Unless explicitly stated otherwise, in cases in which the term “comprising” is used to describe an embodiment of the invention, embodiments in which the invention includes only those specific elements that are described explicitly in the description (i.e. embodiments in which the invention “consists of” rather than “comprises” the listed element or elements) are considered by the inventor to be within the scope of the invention.

As used herein, the abbreviation “MDO” stands for “Machine-Direction Oriented.”

As used herein, the abbreviation “PE” stands for “polyethylene.”

As used herein, the abbreviation “HDPE” stands for “high-density polyethylene.”

As used herein, the abbreviation “LLDPE” stands for “linear low-density polyethylene.”

As used herein, the abbreviations “mLLDPE” and “mLL” stand for “metallocene linear low-density polyethylene,” i.e. LLDPE that has been produced using a metallocene polymerization catalyst.

As used herein, the abbreviation “EVOH” stands for “poly-(ethylene vinyl alcohol).”

As used herein, the abbreviation “ALOX” stands for “aluminum oxide.”

As used herein, the abbreviation “WVTR” stands for “water vapor transmission rate.” Unless otherwise stated, all values of WVTR given herein are WVTR values as determined by the procedure of ASTM standard method F1249-06.

As used herein, the abbreviation “OTR” stands for “oxygen transmission rate.” Unless otherwise stated, all values of OTR given herein are OTR values as determined by the procedure of ASTM standard method D3985.

As used herein, the abbreviation “LB” stands for “low barrier,” and the abbreviation “HB” for “high barrier.”

As used herein, with reference to numerical quantities, the term “about” is used to define a range of ±25% about the nominal value.

The instant invention discloses a laminated multilayer film comprising or consisting of at least one inner layer and at least one outer layer, the use of the multilayer film in the production of packaging materials and packaging, the use of the multiplayer film in packaging materials, packaging materials comprising the laminated multilayer film, and packaging comprising the laminated multilayer film.

In preferred embodiments, the multilayer film additionally comprises an intermediate layer disposed between the inner layer and the outer layer. The film may be produced by any method known in the literature for producing multi-layer polymer films for use in the food industry. Non-limiting examples of methods that may be used to produce the film include adhesive and extrusion lamination processes. In preferred embodiments of the invention, solvent-based adhesive lamination is used to produce the multilayer film.

In preferred embodiments, the outer layer comprises HDPE; in especially preferred embodiments, the HDPE comprises MDO-HDPE. The outer MDO-HDPE layer provides stiffness and puncture resistance as well as esthetically pleasing optical qualities to the packaging. The MDO-HDPE outer layer is typically made from HDPE having a peak melting point of 105-115° C. In typical embodiments, the layer is between 20 and 40 μm thick. In preferred embodiments, it is about 25 μm thick. It is typically produced at a draw ratio of between 3 and 7, and preferably at a draw ratio of 5. In some non-limiting embodiments of the invention, the outer layer is translucent or transparent. In some other non-limiting embodiments, an additive such as calcium carbonate is added to the outer layer during its production in order to give the outer layer a matte finish.

In some embodiments of the invention, a design is printed on the outer layer. Non-limiting examples of designs that may be printed on the outer layer include logos and text (e.g. information regarding the content of a package made from the multilayer film). Any means known in the art for printing on polymer sheets may be used. In preferred embodiments of the invention, gravure or flexo printing is used.

In preferred embodiments, the inner layer comprises HDPE, mLLDPE, and a plastomer. The HDPE is preferably blown HDPE. Any mLLDPE known in the art that is suitable for use in hot-fill food packaging may be used. ELITE (Dow Chemical) and MARLEX (Chevron Phillips) are non-limiting examples of mLLDPE types that may be used in the instant invention. The plastomer may be any type known in the art that is approved for food use and that has a melting point appropriate for use in sealable hot-fill packaging. In preferred embodiments, the plastomer comprises polyethylene and/or poly-α-olefin.

The inner layer may be produced by any method known in the art. In preferred embodiments, the three components are co-extruded to form the inner layer material. In preferred embodiments of the invention, the inner layer is produced by blown film extrusion of the three components. In typical embodiments, the inner layer as a total thickness of between 40 μm and 100 μm. In preferred embodiments, it is about 60 μm thick. In typical embodiments of the invention, the thicknesses of the HDPE/mLL/Plastomer components of the inner layer are in a ratio of about 1:2:1. In typical embodiments of the invention, the inner layer comprises blown HDPE produced at a blow-up ratio (BUR) of 1:2.

In typical embodiments of the invention, the HDPE used in the outer and inner layers is characterized by a density of 0.955 g/cm³, and Φ of about 0.4.

In embodiments of the invention in which the multilayer film comprises an intermediate (adhesive) layer, the intermediate layer comprises an adhesive, an ink, or both. Any appropriate adhesive and ink known in the art may be used. In typical (non-limiting) embodiments, the intermediate layer is 2-3.5 μm thick. In preferred embodiments, the adhesive is water-based. In some non-limiting embodiments of the invention in which the adhesive layer comprises ink, the ink is water-based. In some non-limiting embodiments of the invention in which the adhesive layer comprises ink, the ink is solvent-based. In the most preferred embodiments of the invention, adhesive and, if present, ink approved for use in food packaging are used. In some non-limiting embodiments of the invention in which the adhesive layer comprises ink, the ink may be printed on either of the inner or outer layers according to any method known in the art prior to the lamination of the layers to form the final product.

In some non-limiting embodiments of the invention, the multilayer film comprises one or more coatings or additives. These coatings or additives are especially useful for controlling the physical properties of the final product.

In some preferred embodiments of the invention, at least one layer of the multilayer film is coated in order to reduce the WVTR and OTR. In preferred embodiments of the invention in which the multilayer film is coated, the outer surface (i.e. the surface not facing the intermediate layer) is coated. As a non-limiting example, a three-layer film with no additional additives or coatings (“LB” film) typically has a WVTR of 25-30 g/m²/24 h, and an OTR of 25-30 cm³/m²/24 h. For applications in which lower water vapor and oxygen transmission rates are desired, it is possible to coat one or more of the layers to produce a high-barrier (“HB”) film. As a non-limiting example, in some embodiments, the outer layer is coated with ALOX, typically by vacuum deposition. The ALOX layer is typically 0.001-0.005 μm thick, and preferably about 0.002 μm thick. As a second non-limiting example, in some embodiments, a layer of EVOH, typically about 3-5 μm thick, is co-extruded with the inner layer (preferably with the mLLDPE). In typical embodiments, HB films have a WVTR of 1.5-2.0 g/m²/24 h and an OTR of 2.5-4.5 cm³/m²/24 h.

In preferred embodiments of the invention, the heat seal strength of the laminated film, as measured according to ASTM standard method F2029, is typically ≥25 N/25 mm. In preferred embodiments of the invention, the peel strength, as measured according to ASTM standard method D1876, is ≥300 g/25 mm. In preferred embodiments of the invention, the outer layer of the laminated film (i.e. the surface comprising MDO-HDPE) has a coefficient of friction, as measured according to ASTM standard method D1894-90, of 0.25-0.45. The multilayer film typically has a peak melting point of 130-180° C., preferably 150-160° C.

It is also within the scope of the invention to disclose packaging made from the multilayered film described above. In some non-limiting embodiments of the invention, the packaging is in the form of a bag or pouch. In some preferred embodiments of the invention, the packaging is in the form of a stand-up pouch, the multilayer film being sufficiently stiff to produce a usable stand-up pouch. The bag or pouch is generally made from two pieces of laminated multilayer film that are sealed together by any appropriate means known in the art (e.g. heat sealing) to form a bag that is open on one side. The bag can be heat-sealed after filling. In some embodiments of the invention, the bag has a notch or perforation on at least one side to make breaking the seal easier. The bag may be made resealable, e.g. by inclusion of a zipper-type closure.

In preferred embodiments of the packaging, it is made from a multilayer film comprising an intermediate layer. In particularly preferred embodiments of the invention, the intermediate layer includes ink or dye that forms a pattern such as a design, a logo, or text that relates to the content of the packaging.

In typical embodiments, the packaging is characterized by a WVTR of ≤10 g/m²/day. In preferred embodiments in which the packaging is made from HB film, the WVTR is between 1.5 and 2.0 g/m²/day, while in preferred embodiments in which the packaging is made from LB film, the WVTR is between 25 and 30 g/m²/day. In typical embodiments, the packaging is characterized by an OTR, a of ≤1000 cm³/m²/day. In some preferred embodiments in which the packaging is made from LB film, the OTR is between 25 and 30 cm²/m²/day, while in preferred embodiments in which it is made from HB film, the OTR is between 2.5 and 4.5 cm²/m²/day.

Packaging produced from the multilayer film disclosed herein is suitable for packaging of foods. In particular, it is suitable for hot filling. In preferred embodiments of the invention, the packaging may be heated at a temperature of >85° C. without damage. The packaging is also suitable for use with modified-atmosphere and modified-atmosphere/modified-humidity packaging. In contrast to polyethylene-based packages known in the art that are not suitable for heating above 120° C., packaging made from the multilayer film of the invention disclosed herein can withstand temperatures of up to 150° C., i.e. temperatures more typical of non-recyclable packaging material such as polyester-polyethylene blends. The inner layer, on the other hand, can seal at relatively low temperatures, typically between 120° C. and 150° C., preferably about 140° C.

Because the packaging material disclosed herein is made essentially entirely from PE, the packaging is not only strong and heat-resistant, but fully recyclable as well. Packaging made from the multilayer laminated film of the present invention thus combines the desirable physical properties of packaging made from non-recyclable plastics with the complete recyclability of polyethylene.

1. Packaging comprising a multilayer film, said multilayer film comprising:
an outer layer comprising high-density polyethylene (HDPE);
an inner layer comprising HDPE, metallocene linear low-density polyethylene (mLLDPE), and a plastomer; and
an intermediate layer disposed between said outer layer and said inner layer, said intermediate layer comprising at least one component selected from the group consisting of adhesives, colorants, pigments, and dyes.

2. The packaging according to claim 1, wherein said packaging is characterized by at least one characteristic selected from the group consisting of:
said outer layer comprises machine-direction oriented HDPE (MDO-HDPE); and,
said inner layer comprises blown HDPE.

3. The packaging according to claim 1, wherein said packaging is characterized by at least one characteristic selected from the group consisting of:
said inner layer is characterized by a thickness of between 40 μm and 100 μm; and
said outer layer is characterized by a thickness of between 20 μm and 40 μm.

4. The packaging according to claim 1, wherein said inner layer comprises HDPE, mLLDPE, and plastomer layers characterized by thicknesses in a ratio of about 1:2:1.

5. The packaging according to claim 1, wherein said inner layer comprises plastomer comprising at least one polymer selected from the group consisting of polyethylene and poly-α-olefin.

6. The packaging according to claim 1, wherein said intermediate layer comprises adhesive and ink approved for use in food packaging.

7. The packaging according to claim 1, wherein at least one of said outer layer and said inner layer is coated by a coating.

8. The packaging according to claim 7, wherein at least one of the following is true:
said outer layer is coated with a coating comprising aluminum oxide; and
said inner layer is coated by a coating comprising poly-(ethylene vinyl alcohol) (EVOH).

9. The packaging according to claim 7, wherein said packaging is characterized by at least one characteristic selected from the group consisting of:
a water vapor transmission rate of 1.5-2.0 g/m²/day as determined by ASTM method F1249-06; and,
an oxygen transmission rate of 2.5-4.5 cm³/m²/day as determined by ASTM method D3985.

10. A multilayer film suitable for use in food packaging, said multilayer film comprising:
an outer layer comprising high-density polyethylene (HDPE);
an inner layer comprising HDPE, mLLDPE, and a plastomer; and
an intermediate layer disposed between said outer layer and said inner layer, said intermediate layer comprising at least one component selected from the group consisting of adhesives, colorants, pigments, and dyes.

11. The multilayer film according to claim 10, wherein said multilayer film is characterized by at least one characteristic selected from the group consisting of:
said outer layer comprises machine-direction oriented HDPE (MDO-HDPE); and,
said inner layer comprises blown HDPE.

12. The multilayer film according to claim 10, wherein said packaging is characterized by at least one characteristic selected from the group consisting of:
said inner layer is characterized by a thickness of between 40 μm and 100 μm; and
said outer layer is characterized by a thickness of between 20 μm and 40 μm.

13. The multilayer film according to claim 10, wherein said inner layer comprises HDPE, mLLDPE, and plastomer layers characterized by thicknesses in a ratio of about 1:2:1.

14. The multilayer film according to claim 10, wherein said inner layer comprises plastomer comprising at least one polymer selected from the group consisting of polyethylene and poly-α-olefin.

15. The multilayer film according to claim 10, wherein at least one of said outer layer and said inner layer is coated by a coating.

16. The multilayer film according to claim 15, wherein at least one of the following is true:
said outer layer is coated with a coating comprising aluminum oxide;
said inner layer is coated by a coating comprising poly-(ethylene vinyl alcohol) (EVOH); and
said inner layer is coated by a coating that is co-extruded with said mLLDPE.

17. A method of producing packaging suitable for use with food, said method comprising:
preparing an outer layer comprising an HDPE film characterized by a first thickness;
preparing an inner layer comprising a film HDPE, mLLDPE, and a plastomer, said inner layer characterized by a second thickness;
applying at least one substance selected from the group consisting of adhesives, colorants, pigments, and dyes to a surface of at least one of said outer layer and said inner layer, thereby forming an intermediate layer;
optionally, coating said outer layer with at least one outer layer coating material;
optionally, coating said inner layer with at least one inner layer coating material;
laminating said outer layer, inner layer and said intermediate layer such that said intermediate layer is disposed between said outer layer and said inner layer, thereby producing a multilayer film;
producing packaging characterized by an exterior and an interior and is open on at least one side, by a method selected from the group consisting of:
obtaining two pieces of said multilayer film and sealing together said two pieces of multilayer film such that said inner layers are facing each other in said interior and such that at least one side remains unsealed; and,
folding a piece of said multilayer film such that said inner layers face one another and sealing said folded piece of multilayer film such that at least one side remains unsealed.

18. The method according to claim 17, wherein at least one of the following is true:
said first thickness is 20 μm-40 μm; and
said second thickness is 40 μm-100 μm.

19. The method according to claim 17, wherein at least one of the following is true:
said step of preparing an outer layer comprises preparing an outer layer comprising MDO-HDPE;
said step of preparing an inner layer comprises preparing an inner layer comprising blown HDPE, mLLDPE, and at least one plastomer selected from the group consisting of polyethylene and poly-α-olefin;
said step of preparing an inner layer comprises co-extruding said blown HDPE, mLLDPE, and at least one plastomer; and
said step of preparing an inner layer comprises preparing an inner layer in which said HDPE, said mLLDPE, and said plastomer are characterized by thicknesses having a ratio of about 1:2:1.

20. The method according to claim 17, wherein at least one of the following is true:
said method comprises coating said outer layer with at least one outer layer coating material, said outer layer coating material comprising aluminum oxide;
said method comprises coating said outer layer with at least one outer layer coating material so as to produce a coating characterized by a thickness of 0.001 μm-0.005 μm;
said method comprises coating said outer layer with at least one outer layer coating material, said step of coating said outer layer comprising coating said outer layer with said outer layer coating material by vacuum deposition;
said method comprises coating said inner layer with at least one inner layer coating material, said inner layer coating material comprising EVOH;
said method comprises coating said inner layer with at least one inner layer coating material so as to produce a coating characterized by a thickness of 3 μm-5 μm; and
said method comprises coating said inner layer with at least one inner layer coating material, and said step of coating said inner layer comprises co-extruding said inner layer coating material and said mLLDPE.
